(19) United States
(12) Patent Application Publication
(10) Pub. No.: US 2010/0269122 A1
(43) Pub. Date: Oct. 21, 2010

(54) System and Method of Heuristic Event Detection

(75) Inventors: Jacek Edward Malinowski, Alpharetta, GA (US); Jeffery C. Franklin, Woodstock, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Benchmark Technology Group, Inc., Alpharetta, GA (US)

(21) Appl. No.: 12/424,977

(22) Filed: Apr. 16, 2009

(51) Int. Cl. G06F 9/54

(52) U.S. Cl. 719/317; 719/318; 715/781

(57) ABSTRACT

Disclosed are various embodiments of systems, methods and computer programs that facilitate extensibility of legacy software applications by heuristic event and trigger detection. A host system in which a target application is executed is accessed. At least one trigger within the host system is detected. Triggers are generated by activating functionality of the target application and extracted from a corresponding at least one data object created by the target application. At least one response to triggers are defined, and a helper agent is configured to execute the at least one response.

### BACKGROUND

Legacy software applications are often employed in mainframe computing environments or in modern computing environments including personal or desktop computers. Such legacy software applications often lack appropriate vendor support, access to source code, or other extensibility options in order to extend, modify, or improve the functionality provided. Consequently, the usefulness of such legacy software applications may decline over time as users and customers desire additional features that may not be provided by a software vendor due to economic concerns or the software's inability to support the desired technology or method.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment including an exemplary host system, host peripherals, mainframe and network server according to an embodiment of the present disclosure;

FIG. 2 is a drawing of a host system executing a target application and a discovery tool according to an embodiment of the present disclosure;

FIG. 3 is a drawing of a host system executing a target application and a helper agent according to an embodiment of the present disclosure;

FIG. 4 is a drawing of a block diagram illustrating a discovery tool according to an embodiment of the disclosure;

FIG. 5 is a drawing of a block diagram illustrating a helper agent according to an embodiment of the disclosure;

FIG. 6 is a flow diagram of one example of execution of a discovery tool interacting with a target application according to an embodiment of the disclosure; and

FIG. 7 is a flow diagram of one example of execution of a helper agent interacting with the target application according to an embodiment of the disclosure.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

The present disclosure, in one embodiment, discloses systems and methods configured to monitor a target application executing on a personal computer or other computing system for predetermined data or events that may occur therein. In one embodiment, a target application can be a Windows® based application. An embodiment of the disclosure can monitor and/or interact with elements generated by target applications employing Microsoft Windows® Form and/or Windows-on-Windows (WoW) technologies for execution on a personal or desktop computer. A helper agent configured to monitor these events or occurrences can be executed alongside or accessible to the memory, processor, and other system resources used by a target application. Upon detection of such data or such an occurrence, an embodiment of the disclosure can interrupt the normal flow of the target application and cause other applications to execute or implement other event handling measures in order to produce a desired outcome. Embodiments of the disclosure facilitate the extensibility of legacy applications for which certain features may not be provided by a software vendor due to economic concerns or the software's inability to support a desired technology. As a result, embodiments of the disclosure allow legacy applications to become forward compatible. In other words, legacy applications can be expanded or enhanced, provide new opportunities and support new technologies without making any program changes while providing the capability of rapid deployment.

As one non-limiting example, a helper agent according to an embodiment of the disclosure can monitor a target application for an event, trigger, or other data and take event handling measures that may be unsupported or unimplemented by the target application. In other words, the helper agent can monitor data being processed or steps taken by a target application for the purpose of taking an action if a trigger, event, or other occurrence is identified in the target application by the helper agent. The helper agent, which will be discussed in more detail hereinbelow, can provide extensibility for various functionality of a target application or other software for which the source code or other functions cannot be modified due to licensing restrictions, lack of support by a vendor, or other hurdles as can be appreciated. In some cases, such functionality may not be implemented by a software vendor simply because the vendor is unwilling and/or unable due to economic and/or technical concerns.

In other words, the helper agent can extend, modify, or otherwise improve the functionality of a target application without modifying the application itself, but rather by monitoring the data, events, triggers, or aspects of the target application while it is executing, and providing the extended functionality if an appropriate event or occurrence is detected. Embodiments of the disclosure can be particularly useful in the case of legacy target applications for which source code and/or vendor support to provide extensibility is unavailable.

Prior solutions for providing extensibility for such a target application have included at least one technique that is known in the art as “screen scraping” technology. Screen scraping is employed particularly in mainframe computing environments where personal or desktop computers emulate a legacy terminal configured to connect to a mainframe system or a server via a network. In a screen scrape technique, display data is extracted or copied from the display memory, frame buffer, or other display related memory locations, and then external applications or event handling measures are implemented as desired. In other words, prior solutions have monitored a target application by monitoring the information that is written to a display memory and/or displayed on a screen for a user.

More specifically, in a screen scraping technique, contents of a screen can be used to extract specific data from data buffers, also referred to as terminal storage, video buffers, video storage, video buffer and/or display buffers. Target application monitoring using a screen scraping technique requires that certain data contents are consistently mapped to specific locations on a screen and in a display memory based on the graphical design of the target application. In other words, target application monitoring employing screen scraping relies on selecting specific data elements or other events from the screen or display memory based on a predetermined location. As a non-limiting example, in a legacy application, it may be known that a particular data element may generally reside in a particular row and column of a specific window generated by the legacy application.

However, screen scraping techniques may be inconsistent in their accuracy and/or reliability if data elements drawn to a screen or written to a display memory are relocated, resized, or change in any other way (e.g., font properties altered). To obviate this inconsistency, other screen scrape techniques known in the art attempt to improve on the positional data technique by searching the entire data buffer for specific keywords or delimiters and using offsets to locate their desired data fields. However, a keyword technique can also prove unreliable as keywords may change or appear multiple times on a screen, thereby corrupting data elements returned by such a technique. Accordingly, an embodiment of the disclosure employs operating system application programming interfaces (API's) in order to access data elements and/or other events prior to the data being formatted or passed to the presentation layer of the operating system. Therefore, extracting data based on a position on a screen or keyword location in a display memory is not employed, thereby improving the efficacy of a solution according to an embodiment of the disclosure.

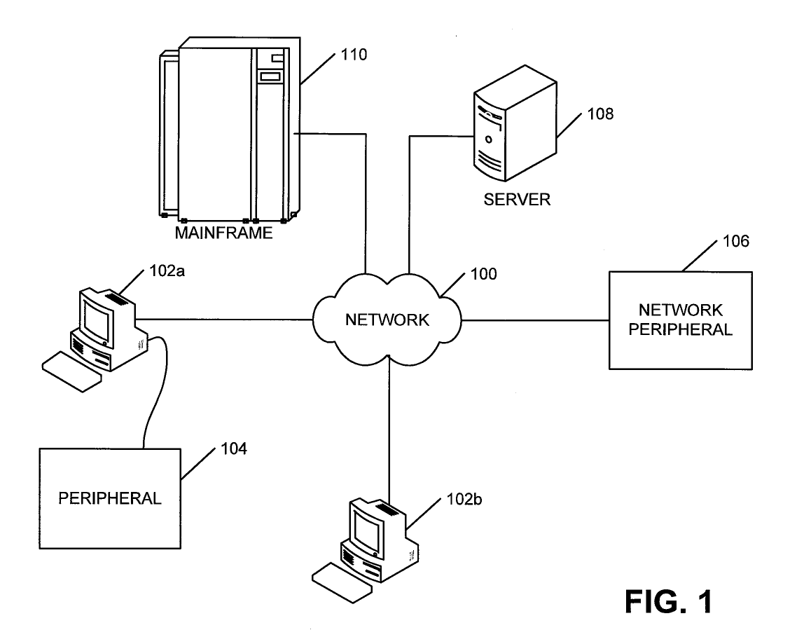

Accordingly, with reference to FIG. 1, shown is a non-limiting networked environment including at least one host system 102a, 102b. The network 100 may include, for example, any type of network environment such as the Internet, intranets, local area networks, wide area networks (WANs), wireless networks, cellular networks, phone networks, or other suitable networks as can be appreciated or any combination of two or more such networks. The host systems 102a, 102b can include personal computers, desktop computers, laptop computers, handheld devices, mobile devices, or other computing environments as can be appreciated. The server 108 may represent multiple servers that may be arranged to work in coordination with each other. Alternatively, such servers may be arranged in some other manner, as can be appreciated. Likewise, the mainframe 110 may represent multiple mainframes that may be arranged to work in coordination with one another or other mainframes. It should be emphasized that the depicted networked environment is a non-limiting exemplary application, and shown to illustrate the various concepts discussed herein.

Accordingly, a target application can be executed within a host system 102 and take many forms. As one non-limiting example, a target application can include a bank teller application that is a legacy application configured to assist a teller with over the counter banking transactions. A host system 102a can also be coupled to a peripheral 104 with which a target application may interact. As one non-limiting example, the peripheral 104 can include a cash dispensing machine with which a bank teller application can interact in order to dispense cash requested by a bank teller. Such a peripheral 104 can also take the form of a network peripheral 106. That is, a peripheral 104 may be attached to the network 100 and accessible to a host system 102b via the network 100.

It may be desired to extend the functionality of such an exemplary teller application. As one example, it may be desired to extend the functionality of the teller application to interact with a new cash dispenser and/or cash recycler in order to facilitate teller transactions. However, the software implementing the teller application may not support the desired functionality. Alternatively, the source code of the software implementing the teller application may be unavailable, making implementation of the desired functionality difficult, or the software vendor may be unwilling to implement the desired functionality of a legacy software application due to economic reasons. In addition, a teller application may also interact with a server 108 and/or mainframe 110 in order to process account debits, account credits, or perform other back office transactions that may occur in a banking environment. As originally developed, the software implementing the teller transactions may not support such functionality for reasons noted above.

As another non-limiting example, a target application executable on a host system 102a, 102b can include an identity verification application with which a person's identity may be verified on the basis of a name, address, etc. against identity information residing on a server 108 or other system provided by a credit reporting service, databroker, personal information content provider, or public information service provider. As one example, it may be desired to extend the functionality of the identity verification application to interact with a different database to perform additional identity checks that were not supported by the software as originally conceived. As noted above, the source code of the software implementing the identity verification application may be unavailable, making implementation of the desired functionality difficult, or the software vendor may be unwilling to implement the desired functionality of a legacy software application due to economic reasons.

As yet another non-limiting example, a target application can include a shipping management application configured to facilitate data entry and/or shipment management. As one example, it may be desired to extend the functionality of the shipping management application to communicate with an unsupported shipping label printing system responsive to a trigger generated in response to weighing a parcel with a scale coupled to a host system in which the shipping management application is executed. As noted above, the source code of the software implementing the shipping management application may be unavailable, making implementation of the desired functionality difficult, or the software vendor may be unwilling to implement the desired functionality of a legacy software application due to economic reasons. The embodiment of the disclosure can extend the functionality of the application to support hardware products that were unknown when those applications were conceived; in this example, a highly specialized bar code printer.

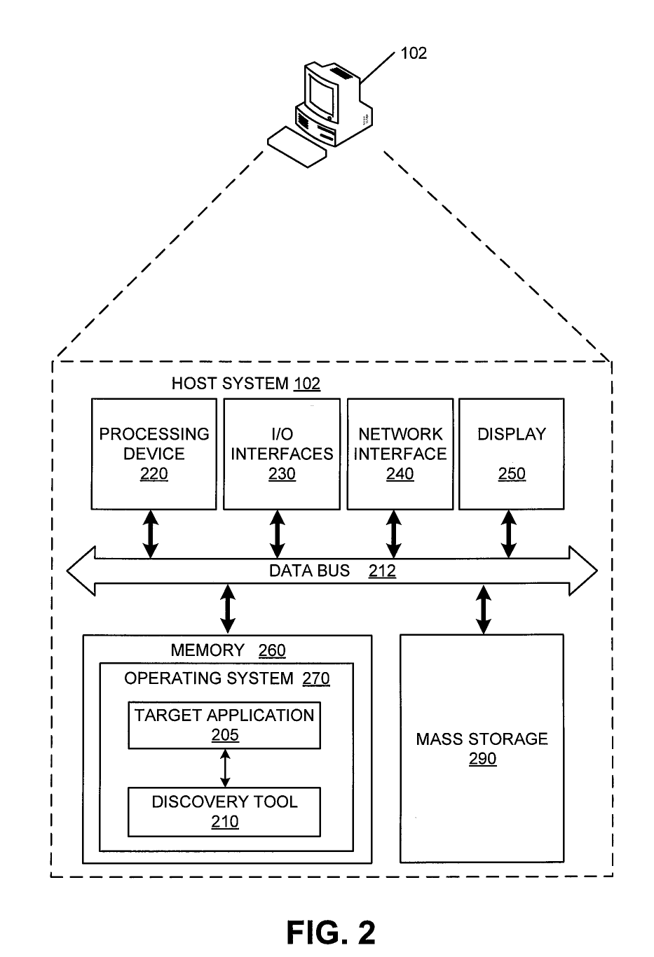

Reference is now made to FIG. 2, which depicts a host system 102 in which a target application 205 can be executed. A target application 205 can include various exemplary functionality as described above, and in accordance with one non-limiting embodiment of the disclosure, the target application 205 is configured to take advantage of Microsoft Windows® Form and/or Windows-on-Windows (WoW) technologies for execution on a personal computer, desktop computer, or laptop computer running Microsoft Windows® as an operating system. Accordingly, a discovery tool 210 is executed alongside the target application 205 in the host system 102 in order to monitor the target application 205. With the discovery tool 210 executing, the target application 205 can also be executed and various normal usage activities can be conducted by a user in order to allow the discovery tool 210 to monitor and gather data about the target application 205.

Reference is now made to FIG. 2, which is an exemplary embodiment of the host system 102 from FIG. 1. For some embodiments, the host system 102 may be incorporated as some type of computing device. Generally speaking, the host system 102 may be any one of a wide variety of wired and/or wireless computing devices, such as a desktop computer, portable computer, dedicated server computer, multiprocessor computing device and so forth. Irrespective of its specific arrangement, the host system 102 may comprise, among other components, a processing device 220, input/output interfaces 230, a network interface 240, and a display connected across a data bus 212. One of ordinary skill in the art will appreciate that the host system 102 can, and typically will, comprise other components, which have been omitted for purposes of brevity.

The display can comprise a computer monitor or a plasma screen for a PC or a liquid crystal display (LCD), for example. The processing device 220 can include a custom-made or commercially available processor, a central processing unit (CPU), a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 260 shown in FIG. 2 can include any one of a combination of volatile memory elements (e.g., random-access memory RAM, such as DRAM, and SRAM, etc.) and nonvolatile memory elements (e.g., ROM, hard drive, tape, CDROM, etc.). The memory 260 may store a native operating system 270, one or more native applications, emulation systems, or emulated applications for any of a variety of operating systems and/or emulated hardware platforms, emulated operating systems, etc. Again, one of ordinary skill in the art will appreciate that the memory 260 can, and typically will, comprise other components, which have been omitted for purposes of brevity. In addition, the processing device 220 may represent multiple processors and the memory 260 may represent multiple memories that operate in parallel. In such a case, the bus interface 212 may be an appropriate network that facilitates communication between any two of the multiple processors, between any processor and any one of the memories, or between any two of the memories, etc. The processing device 220 may be of electrical, optical, or of some other construction as can be appreciated by those with ordinary skill in the art.

The host system 102 may further comprise mass storage 290. The mass storage 290 may be, for example, a disk drive, flash memory, or any other of a wide variety of storage devices capable of storing data. For example, the applications may include a target application 205 being monitored according to an embodiment of the disclosure. The applications can also include a discovery tool 210 executed alongside the target application 205 and configured to monitor the target application 205 to detect triggers to which a user defined response can be specified. In one embodiment, the discovery tool 210 executes as the target application 205 is executed and the various functionalities of the target application 205 are stepped through. The discovery tool 210 accordingly detects various data elements and other events, collectively referred to herein as triggers, that are caused by target application 205 usage.

The target application 205 shown in FIG. 2 may be a banking application, identity verification application, shipping management application, or any software application as can be appreciated. The target application 205 can also be configured to interact with a peripheral 104, network peripheral 106, a server 108, a mainframe 110, etc. as can be appreciated. When implemented in software, it should be noted that any of the modules configured to implement a target application 205, discovery tool 210 or other application can be stored on a variety of computer-readable medium for use by, or in connection with, a variety of computer-related systems or methods. In the context of this document, a computer-readable medium may comprise electronic, magnetic, optical, or other physical device or apparatus that can contain or store a computer program for use by or in connection with a computer-related system or method. The interface can be embedded in a variety of computer-readable medium for use by, or in connection with, an instruction execution system, apparatus, or device, such as a computer-based system, processor-containing system, or other system that can fetch the instructions from the instruction execution system, apparatus, or device and execute the instructions.

In the context of this disclosure, a “computer-readable medium” stores, communicates, propagates, or transports the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer-readable medium may include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), a portable compact disc read-only memory (CDROM) (optical), a digital versatile disc (optical), a high definition digital versatile disc (optical), and other optical media.

Input/output interfaces 230 comprise any number of interfaces for the input and output of data. For example, where the host system 102 comprises a personal computer, the components within the system may interface with a user input device such as a keyboard, a mouse, or a remote controller. The host system 102 may also include a network interface 240 for transmitting and/or receiving data over a network. As a non-limiting example, the network interface 240 may include a modulator/demodulator (e.g., a modem), wireless (e.g., radio frequency (RF)) transceiver, a telephonic interface, a bridge, a router, network card, etc.

In one embodiment, the discovery tool 210 can detect the occurrence of an event, generation of data elements, triggers, or other information (which may collectively be referred to herein as a trigger) within the target application 205 and allow a user to specify or define a response. As noted above, a discovery tool 210 in accordance with the disclosure can detect such events or occurrences prior to data or other information being passed to the operating system presentation layer, thereby removing many of the concerns associated with screen scraping techniques employed in the prior art. Accordingly, the discovery tool 210 can detect a trigger, such as, in the case of a banking application, a request to withdraw cash from a teller, and allow a user to define a response to such a trigger. Accordingly, trigger responses for various detected triggers can be assembled in a table built by the detection tool 210 in order to pair detected triggers with associated trigger responses. Such a table can be stored in memory or mass storage and associated with a helper agent 302 application that can be subsequently executed alongside a target application 205 in order to provide the application extensibility described herein.

In one embodiment, the discovery tool 210 can detect triggers by monitoring activity of a target application 205, particularly a target application's 205 interaction with graphical application programming interfaces (APIs). Multiple detection methods can be employed, each running as asynchronous tasks within the trigger detection module 504. In one embodiment, such APIs can include the target application's 205 interaction with Microsoft Windows® Forms APIs and/or the Windows on Windows (WoW) subsystem that permits 16-bit legacy applications to implement graphical functionality in a 32-bit Microsoft Windows® operating system. In one embodiment, the discovery tool 210 can access the target application 205 form title using the Windows® GETTEXT API command to identify the name of an application or file related to the target application 205. The discovery tool 210 can also monitor a target application's 205 interaction with any other operating system APIs in order to access various data elements generated by the target application 205. In order to reliably extract data elements, the discovery tool 210 can examine the data objects generated by the target application 205, where the data objects are generated by the target application's 205 interaction with an operating system API.

As one non-limiting example, forms in certain Windows® applications may contain ‘fields’ or child objects that can be collected and parsed. By obtaining a pointer to or address of the definition of the Windows Form in memory, and regardless of whether the form is enabled, disabled, visible or hidden, the discovery tool 210 can step through the address space and build a table that may include but not be limited to: a handle of the child object on the form, a ClassName of the child object, an ordinal of the child object, a unique identifier of the object, the object text, the style and other field attributes of the child object and other possible object properties and characteristics such as size, owner, owner properties and coordinate information that should be appreciated. The desired target objects are captured by the discovery tool 210 and employed to configure a helper agent 302 as discussed hereinbelow. The data elements classified in the table can be accessed by the helper agent 302 to achieve the desired outcome or execute a desired response configured by a user. Accordingly, rather than relying on extracting data from a presentation layer or by employing other methods used in “screen scraping” technology, accessing program controls and data at this level provides extensibility of legacy applications more reliably.

In the above example, by detecting certain calls by the target application of Windows Forms, WoW functionality, or other target application activity, the discovery tool 210 can detect properties of data elements generated by the target application 205 prior to the data elements being passed to the presentation layer of the operating system. As a non-limiting example, a target application's 205 WndProc procedure can be intercepted by the discovery tool 210 and various Windows Messages passed via the WndProc procedure as defined in the Microsoft 32-bit API can be evaluated, processed and returned to the target application 205. In some cases, the discovery tool 210 can capture keystrokes or keystroke combinations in a WINHOOK for the keyboard object.

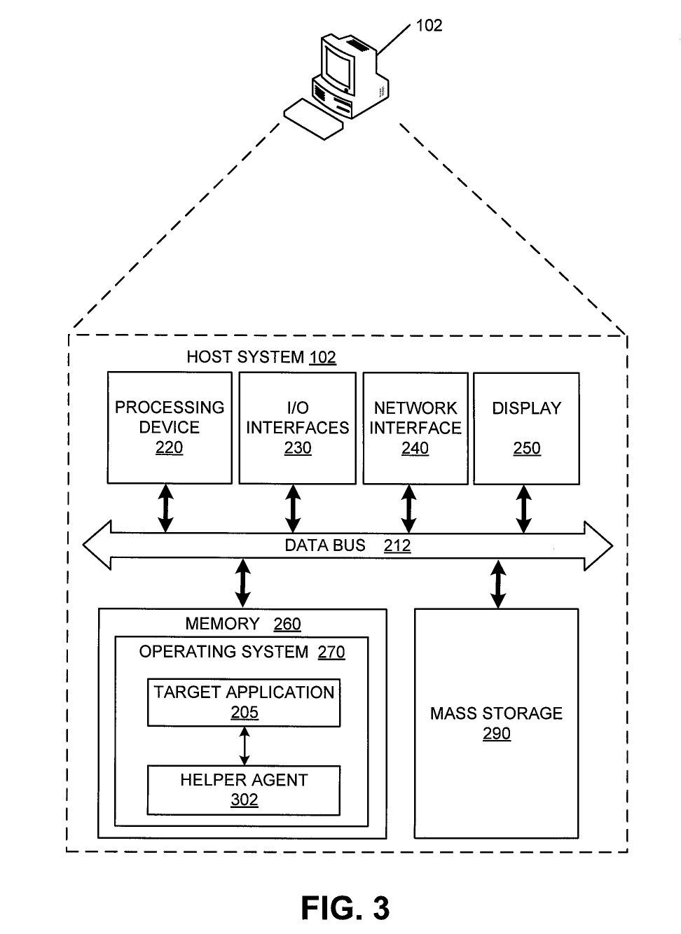

In other words, in contrast to screen scraping methods employed by the prior art, embodiments of the disclosure can extract data elements from a legacy software application using several methods, without reliance upon extracting such data from a display memory, buffer, etc. which can be unreliable. Accordingly, the discovery tool 210 can catalog the various data elements generated by the target application 205 in a table or other structure that may be later relied upon to configure a helper agent 302 (FIG. 3), which will be discussed hereinbelow.

In the non-limiting example of a target application 205 employing Windows Form® or WoW functionality, the discovery tool 210 can detect triggers in various ways. In one embodiment, the discovery tool 210 can detect the generation of a Windows Form data object that is generated by the target application. Accordingly, the discovery tool 210 can extract a data element related to the detected data object such as the form title or caption bar. The discovery tool 210 can further extract additional data elements that may exist within or in relation to the data object associated with an extracted form title or caption bar. The discovery tool 210 can then generate a table for the data object associated with the form title or caption bar in which the various data elements can be presented so that a response can be determined.

In one embodiment, a particular rule or response can be defined based upon a particular form title or caption bar that is extracted from such a data object. As a non-limiting example, if a form title or caption bar having a value of “Withdrawal” is detected by the discovery tool 210, the discovery tool 210 can generate a table in which various data elements that may correspond to form elements of the data object can be stored. Accordingly, the discovery tool 210 can present such a generated table to a user determining a response to a trigger and allow the user to define a response as well as one or more data elements to incorporate in such a response.

In another non-limiting example, the discovery tool 210 can also identify data objects generated by target application 205 calls to an API to generate “hidden” windows or other elements that are not displayed. Data relevant to a desired functionality may reside in a hidden window that is not presented to the operating system presentation layer and rendered for display. Accordingly, a user configuring a response to a trigger may utilize data residing in hidden windows or other hidden graphical elements defined by data objects generated by the target application 205.

Accordingly, reference is made to FIG. 3, which depicts a host system 102 of FIG. 2 executing a target application 205 and a helper agent 302. The host system of FIG. 2 has executed the discovery tool 210 and therefore, the helper agent 302 has access to various user defined responses to triggers that are detected by the helper agent 302. As noted above in reference to the discovery tool 210, triggers can be detected in a target application and then data presented to a user to allow a user to define a response to a detected trigger and configured the helper agent 302. Accordingly, upon configuration of the helper agent 302, the helper agent 302 can monitor execution of a target application 205 and implement a response to a detected trigger as defined by a user.

In one embodiment, the helper agent 302 can extract data elements or other information associated with a trigger and implements an internal event handler. As one non-limiting example, in the case of a shipping application, the helper agent 302 can, in response to a detected trigger of a weight input from a scale, issue commands to a label printer instructing that a shipping label be printed as a result of dynamically extracting data from sources unknown to the shipping application. Alternatively, the helper agent 302 can, in response to the same detected trigger of a weight input from a scale, launch an external or side application which can facilitate the printing of a shipping label. Accordingly, in the above example, the helper agent 302 can facilitate extensibility of the functionality of the shipping application without modification, decompiling, recompiling, and/or vendor support.

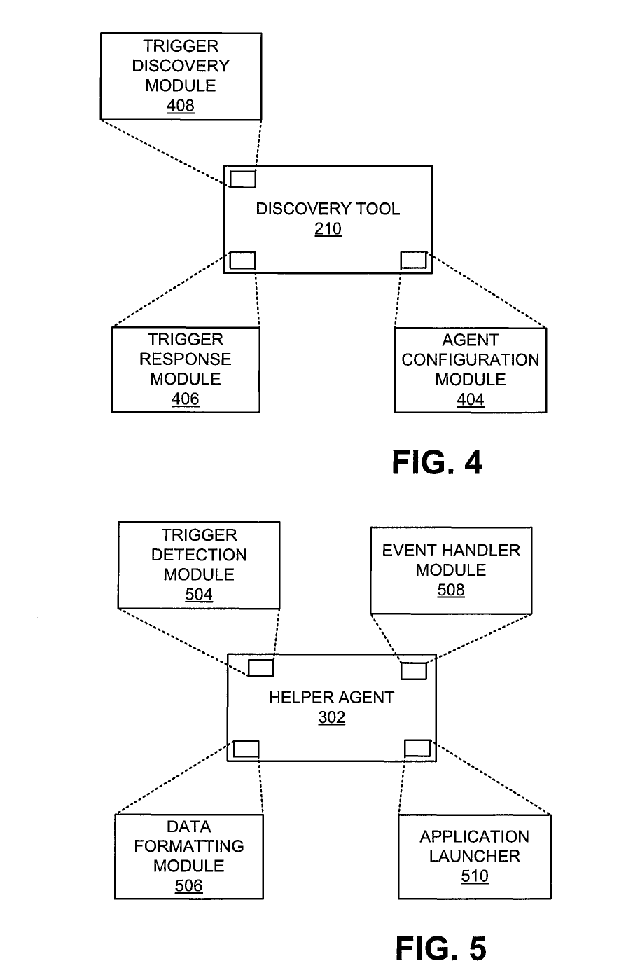

Reference is now made to FIG. 4, which depicts a functional block diagram of a discovery tool 210 according to an embodiment of the disclosure. It should be noted that some components not essential for understanding (by persons skilled in the art) of the discovery tool 210 and/or helper agent 302 are omitted for purposes of brevity and ease of depiction. In addition, it should also be appreciated that the depicted block diagram is but one exemplary depiction of a discovery tool 210 and/or helper agent 302 according to the disclosure. As is the nature with software applications and software development, there are various possible implementations a person of ordinary skill in the art may choose according to an embodiment of this disclosure.

The discovery tool 210, as depicted in FIG. 4, can include a trigger discovery module 408 that is configured to monitor a target application 205 to detect various target application 205 triggers as noted above. The discovery tool 210 also includes a trigger response module 406 that allows a user to define a response to a trigger detected by the trigger discovery module 408. The trigger response module 406 allows a user to define a side application or internal event handler that can be launched or initiated in response to a certain trigger. In one embodiment, the trigger response module 406 allows a user to designate an external application that can be launched in response to a detected trigger in order to provide functionality and/or extensibility that the target application 205 fails to provide.

As a non-limiting example, in the case of a bank teller application configured to communicate with a cash dispensing and/or cash recycling machine, upon detection of a trigger (e.g. a teller entering a standard cash check transaction), the helper agent 302 can detect such a trigger and launch a side application configured to provide the commands to cash dispensing hardware that the legacy target application 205 does not support.

The discovery tool 210 can further include an agent configuration module 404. The agent configuration module 404 can allow a user to specify a response to triggers and generate a table that can be stored in mass storage 390 or other storage or memory location that defines the responses a helper agent 302 should take in response to a detected trigger generated by a target application 205. In other words, the agent configuration module 404 can allow the discovery tool 210 to enable a user to define the actions that a helper agent 302 takes in response to various triggers generated by the target application 205.

Accordingly, reference is now made to FIG. 5, which depicts a functional block diagram of a helper agent 302 according to an embodiment of the disclosure. As previously noted the helper agent 302 can be executed alongside a target application 205 and configured to detect triggers generated in the target application 205 for which a user, via the discovery tool 210, has defined responses in the form of side applications to be launched or internal event handling measures. Accordingly, the trigger detection module 504 can detect various triggers generated in the target application 205 as noted above. As a non-limiting example, the trigger detection module 504 can detect the creation and/or manipulation of a caption bar and/or form title having a certain name the trigger detection and discovery methods. Accordingly, the helper agent can execute additional business logic or other responses defined in the helper agent 302 by a user.

The helper agent 302 can also include a data formatting module 506 that can be configured to extract data or other events generated by a target application 205 trigger. As a non-limiting example, in the case of a bank teller application in which a teller desires to perform a transaction for which a trigger response has been defined by the discovery tool 210, the data formatting module 506 can extract data provided by a teller using the target application 205 and format the data for a side application or internal event handler specified by a user as a response to the trigger.

The helper agent 302 can further include an event handler module 508 that is configured to perform internal event handling measures defined by a user, should such measures be specified as a response to a trigger detected by the trigger detection module 504. As a non-limiting example, in the case of a bank teller application in which a teller desires to perform a transaction that directs a cash dispenser to dispense cash related to a transaction, the helper agent 302 may be configured, in response to a trigger detection by the trigger detection module 504, to issue commands on behalf of the bank teller application to a cash dispenser, if the legacy bank teller application fails to incorporate the desired functionality or possess the extensibility to issue the commands to a chosen cash dispenser. In the above example, the event handler module 508 can issue commands to the cash dispenser with data retrieved and formatted by the data formatting module 506.

As an alternative non-limiting example, a target application's 205 WndProc procedure can be intercepted and the Windows Messages as defined in the Microsoft 32-bit API can be evaluated, processed and returned to the target application 205. The Messages can be altered by the event handler module 508 to execute a desired response. In some cases, the trigger detection module 504 can capture keystrokes or keystroke combinations in a WINHOOK for the keyboard object.

The helper agent 302 can further include an application launcher 510 that is configured to launch external or “side” applications defined by a user as a response to a trigger detected by the trigger detection module 504. As a non-limiting example, continuing the above example of a bank teller application in which a teller desires to perform a transaction for which a legacy bank teller application may not fully support, the helper agent 302 can be configured to invoke the application launcher module 510 in order to cause the helper agent 302 to execute a side application that provides such support. For example, if the bank teller application does not provide support for newly emerging regulatory requirements for a transaction attempted by a teller, the helper agent 302 can, via the application launcher module 510, invoke an external application and interrupt the target application 205 that enables a teller and/or bank to capture the information required to comply with the regulatory requirements, and then resuming the target application 205 and allowing a teller to complete the transaction.

As an alternative non-limiting example and analogous to the example noted above, a target application's 205 WndProc procedure can be intercepted and the Windows Messages as defined in the Microsoft 32-bit API can be evaluated, processed and returned to the target application 205. The Messages can be altered by the application launcher module 510 to execute a desired response. In some cases, the trigger detection module 504 can capture keystrokes or keystroke combinations in a WINHOOK for the keyboard object.

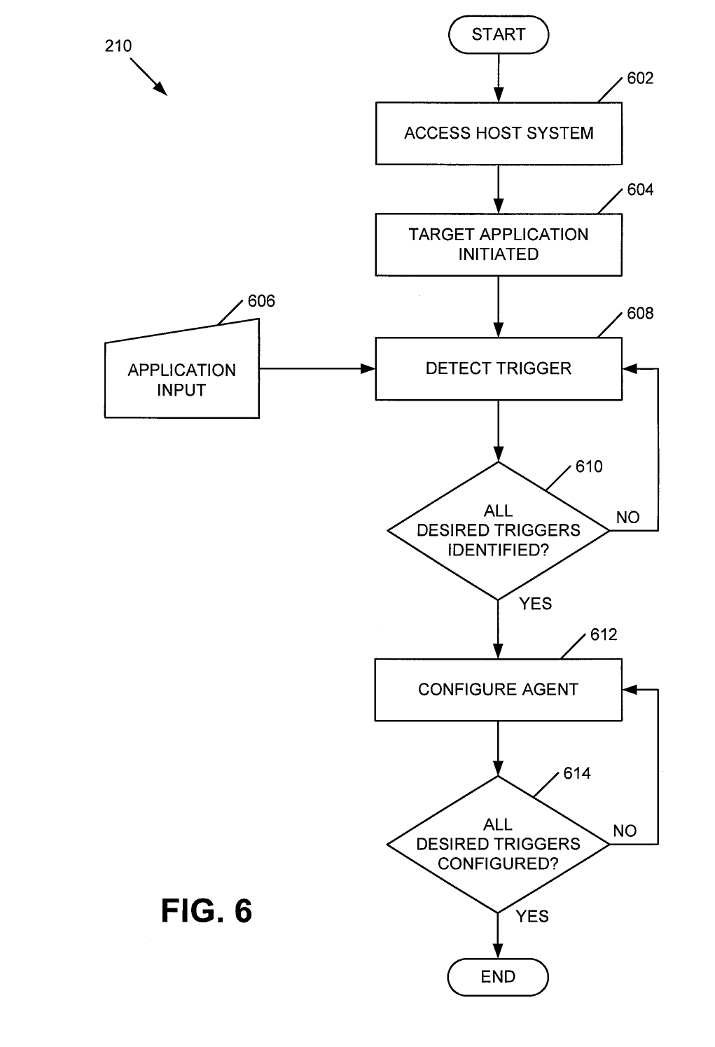

Reference is now made to FIG. 6, which depicts one example of execution of a discovery tool 210 according to an embodiment of the disclosure. The flow chart may also be viewed as depicting a method in accordance with the disclosure. In step 602, the discovery tool 210 accesses the host system 102. In one embodiment, the discovery tool 210 can be executed alongside a target application 205 within a host system 102, thus having access to the memory and other system resources with which the target application 205 is interacting. In step 604, the target application 205, which will be monitored by the discovery tool 210 in order to detect certain events, data elements or other occurrences, is initiated. In step 606, application input is generated by the target application 205, which can be monitored by the discovery tool 210.

Accordingly, in step 608, the discovery tool 210 can detect a trigger to which a user defined response can be specified. As noted above in various examples, such a trigger can involve the occurrence of an event, the generation of a particular data element, or other trigger as can be appreciated. In one embodiment, the detected trigger can emanate from a bank teller application directing legacy cash dispenser to dispense cash. Accordingly, a user defined response to such a trigger can include modified cash dispensing commands tailored for a modern cash dispenser. As an alternative non-limiting example, in the non-limiting case of a target application 205 configured to verify a person's identity, a user defined response may include the launching of a third party application configured to perform additional background checks or other identity verifications or authentications by accessing a data aggregation service, private intelligence service or credit reporting service not supported by the target application 205. In this scenario the detected trigger can include the person's name or address being entered into the target application 205.

As yet another non-limiting example, in the case of a target application 205 configured as a bank teller application, if the application fails to support current regulatory requirements, which can often change over time, and if vendor support or access to application source code is unavailable, a user defined response to a teller transaction identified as a trigger can include the launching of an application configured to support the collection of data necessary to support banking regulatory requirements. In this event, as one example, the detected trigger can include a deposit amount, which may exceed a regulatory threshold that may trigger reporting or data collection requirements that are not supported by a legacy target application 205. Other examples of trigger detection and user driven response definition should be appreciated.

In step 610, it is determined whether all desired triggers have been identified. In one embodiment, it can be determined whether all desired triggers have been identified if all aspects of the target application 205 being monitored by the discovery tool 210 have been executed by a user. In step 612, a helper agent 302 is configured. The helper agent 302 configuration allows a user or automated process to define a response to various triggers identified by the discovery tool. In the exemplary target applications 205 noted above, various user specified responses to the detection of a certain trigger are disclosed. The discovery tool 210 can accordingly generate a user interface allowing a user to define and/or specify responses to detection of various data elements, events, or occurrences within the target application 205. In step 614, if all detected triggers for which a user desires to specify a response are configured, then an execution of the discovery tool 210 can terminate.

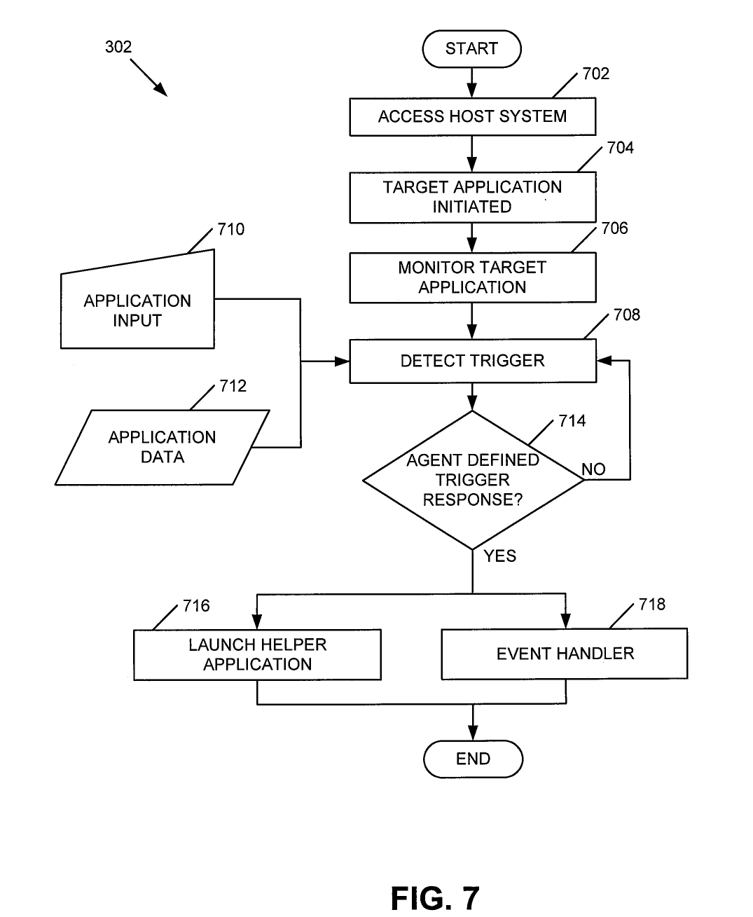

Reference is now made to FIG. 7, which depicts one execution of a helper agent 302 according to an embodiment of the disclosure. The flow chart may also be viewed as depicting a method in accordance with the disclosure. In step 702, the helper agent 302 accesses the host system 102. In one embodiment, the helper agent 302 can be executed alongside a target application 205 within a host system 102, thus having access to the memory and other system resources with which the target application 205 is interacting. In step 704, the target application 205, which will be monitored by the discovery tool 210 in order to detect certain events, data elements or other occurrences, is initiated. In step 706, the helper agent 302 is directed to monitor a target application 205 as noted above.

In step 708, the helper agent 302 detects triggers generated by the target application 205 in response to application input 710 and/or application data 712 that may be generated by a user's usage of the target application 205. As noted above, application input 710 can include various functionality of a target application 205 executable by a user within a host system 102. In addition, application data 712 can include various data elements generated by usage of the target application 205. In step 714, the helper agent 302 determines whether, for a detected trigger, there is a user defined response that was configured by the discovery tool 210. If no response has been defined by the discovery tool 210, then the helper agent returns to step 708 to continue the detection of triggers.

If the discovery tool 210 has specified a response to a detected trigger, the response can comprise the launching of a helper application in step 716 that is configured to provide the extensibility and/or additional functionality desired by a user that the target application 205 fails to provide. Alternatively, the response to a detected trigger can also comprise an event handler 718 internal to the helper agent 302 without launching a helper application. As a non-limiting example, the helper agent 302 can issue commands to a peripheral or a network peripheral without resorting to the launching of a helper application. Accordingly, certain user defined responses to a detected trigger can be made more efficient through the use of an internal event handler 718.

The flow charts of FIGS. 6-7 show the functionality and operation of an implementation of a helper agent 302 and discovery tool 210 according to one embodiment of the disclosure. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIG. 6-7 show a specific order of execution, it is understood that the order of execution may differ from that which is depicted. For example, the order of execution of two or more blocks may be scrambled relative to the order shown. Also, two or more blocks shown in succession in FIGS. 6-7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the functionality of the disclosed systems is expressed in the form of software or code, it can be embodied in any computer-readable medium for use by or in connection with an instruction execution system such as, for example, a processor in a computer system or other system. In this sense, the functionality may comprise, for example, statements including instructions and declarations that can be fetched from the computer-readable medium and executed by the instruction execution system. As noted above, in the context of the present disclosure, a “computer-readable medium” can be any medium that can contain, store, or maintain the network page for use by or in connection with the instruction execution system.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method, comprising the steps of:
accessing a host system, the host system being a computing system in which a target application can be executed;
executing the target application in the host system;
detecting at least one trigger within the host system, the at least one trigger generated by activating functionality of the target application and extracted from a corresponding at least one data object created by the target application;
defining at least one response to the at least one trigger; and
configuring a helper agent to execute the at least one response.

2. The method of claim 1, wherein the at least one data object is an object created by the target application in response to activating functionality of the target application.

3. The method of claim 1, wherein the at least one data object is extracted from the target application prior to data elements of the at least one data object being presented to an operating system presentation layer for rendering on a display.

4. The method of claim 1, wherein the at least one data object further comprises an object representing a graphical window generated by the target application using an operating system graphical application programming interface.

5. The method of claim 1, wherein the at least one data object is at least one of: a data element corresponding to a title bar associated with an object representing a window, and at least one data element corresponding to contents of the window.

6. The method of claim 4, wherein the step of detecting the at least one trigger further comprises the steps of:
stepping through an address space in a memory of the host system, the address space corresponding to the at least one data object generated by the target application; and
generating a table including at least one data element of the at least one data object.

7. The method of claim 5, wherein the step of detecting at least one trigger further comprises determining at least one attribute that describes at least one of: whether the window is hidden, whether the window is disabled, whether the window is visible, whether the window is idle, and whether the window is executed.

8. The method of claim 1, wherein the at least one response is at least one of: launching of an external application and issuing at least one command.

9. The method of claim 1, wherein the at least one response comprises at least one of: transmitting data to a peripheral device, receiving data from a peripheral device, transmitting data from a network, and receiving data from the network.

10. A method, comprising the steps of:
accessing a host system, the host system being a computing system in which a target application can be executed;
executing the target application in the host system;
detecting at least one trigger within the host system, the at least one trigger generated by activating functionality of the target application and extracted from a corresponding at least one data object created by the target application; and
executing at least one response to the at least one trigger.

11. The method of claim 10, wherein the at least one response is at least one of: launching of an external application and issuing at least one command.

12. The method of claim 10, wherein the at least one data object is an object created by the target application in response to activating functionality of the target application.

13. The method of claim 10, wherein the at least one data object is extracted from the target application prior to data being presented to an operating system presentation layer for rendering on a display.

14. The method of claim 10, wherein the at least one response comprises at least one of: transmitting data to a peripheral device, receiving data from the peripheral device, transmitting data from a network, and receiving data from the network.

15. The method of claim 14, wherein the peripheral device is a cash dispenser.

16. The method of claim 14, wherein the host system is coupled to the network and at least one of a server and a mainframe are coupled to the network.

17. A system for monitoring a target application, comprising:
a trigger discovery module configured to access a host system, the host system being a computing system in which the target application is executed, the trigger discovery module further configured to detect at least one trigger within the host system, the at least one trigger generated by the activating functionality of the target application and extracted from a corresponding at least one data object created by the target application;
a trigger response module configured to define at least one response to the at least one trigger; and
an agent configuration module configured to configure a helper agent to execute the at least one response.

18. The system of claim 17, wherein the at least one data object is an object created by the target application in response to activating functionality of the target application.

19. The system of claim 17, wherein the trigger discovery module extracts at least one data object from the target application prior to data elements of the at least one data object being presented to an operating system presentation layer for rendering on a display.

20. The system of claim 17, wherein the at least one data object further comprises an object representing a graphical window generated by the target application using an operating system graphical application programming interface.

21. The system of claim 20, wherein the trigger discovery module is further configured to:
step through an address space in memory of the host system corresponding to the at least one data object generated by the target application; and
generate a table including at least one data element of the at least one data object.

22. The system of claim 17, wherein the at least one response is at least one of: launching of an external application and issuing at least one command.

23. A system for monitoring and extending a target application, comprising:
trigger detection module configured to access a host system, the host system being a computing system in which the target application is executed, the trigger detection module further configured to detect at least one trigger within the host system, the at least one trigger generated by the activating functionality of the target application and extracted from a corresponding at least one data object created by the target application; and
logic configured to execute at least one response to the at least one trigger.

24. The system of claim 23, wherein logic configured to execute the at least one response is at least one of: an application launcher configured to launch an external application and an event handler module configured to issue at least one command.

25. The system of claim 23, wherein the at least one data object is an object created by the target application in response to activating functionality of the target application.

26. The system of claim 23, wherein the at least one response comprises at least one of: transmitting data to a peripheral device, receiving data from the peripheral device, transmitting data from a network, and receiving data from the network.
